(19) United States
(12) Patent Application Publication
(10) Pub. No.: US 2018/0139230 A1
(43) Pub. Date: May 17, 2018

(54) IDENTIFICATION AND MITIGATION OF ATTACKS IN A CONTENT DELIVERY NETWORK (CDN)

(71) Applicant: Level 3 Communications, LLC, Broomfield, CO (US)

(72) Inventor: Christopher Newton, Westlake Village, CA (US)

(21) Appl. No.: 15/351,744

(22) Filed: Nov. 15, 2016

(51) Int. Cl. H04L 29/06; H04L 29/12

(52) U.S. Cl. CPC H04L 63/1458; H04L 67/42; H04L 63/1433; H04L 61/106

(57) ABSTRACT

A computer-implemented method determines which content providers are under denial of service (DoS) attack in a content delivery network (CDN). The system maintains a mapping having, for each content provider, a corresponding set of cluster/virtual IP address (VIP) pairs, wherein the set of cluster/VIP pairs is unique or nearly unique for each content provider, and wherein client requests for content from a particular content provider are directed to one or more VIPs in the set of cluster/VIP pairs associated with that particular content provider. The mapping is used to determine a set of one or more possible attack candidates when the system is under DoS attack. The system attempts to mitigate the DoS attacks on the possible attack candidates.

### BACKGROUND OF THE INVENTION

### Copyright Statement

This patent document contains material subject to copyright protection. The copyright owner has no objection to the reproduction of this patent document or any related materials in the files of the United States Patent and Trademark Office, but otherwise reserves all copyrights whatsoever.

### FIELD OF THE INVENTION

This invention relates to content delivery and content delivery networks. More specifically, this invention relates to identification and mitigation of distributed denial of service attacks in content delivery networks (CDNs).

### BACKGROUND

Internet-based resources such as web sites and the like are under constant threat and attack. One type of attack is a so-called denial-of-service (DoS) attack. A DoS attack on a machine or network resource attempts to make that machine or network resource unavailable to its intended users. Denial of service is typically accomplished by flooding the targeted machine or resource with superfluous requests in an attempt to overload systems and prevent some or all legitimate requests from being fulfilled. (See, e.g., US-CERT (United States Computer Emergency Readiness Team), Security Tip (ST04-015) Understanding Denial-of-Service Attacks [Original release date: Nov. 4, 2009, last revised: Feb. 6, 2013], available at https://www.us-cert.gov/ncas/tips/ST04-015).

A distributed denial-of-service (DDoS) attack is a DoS attack where the attack source is more than one unique IP address. There are various other kinds of DoS attacks (e.g., distributed reflected denial of service (DRDoS) attacks). As used herein, unless specifically stated otherwise, the term DoS attacks refers to all kinds of DoS attacks, including DDoS and DRDoS attacks.

There are various techniques and devices available to mitigate DoS attacks (See, e.g., “Protection Against Denial of Service Attacks: A Survey,” Georgios Loukas and Gülay Öke, Intelligent Systems and Networks Group, Imperial College London, London, UK, The Computer Journal (2010) 53 (7): 1020-1037). However, a CDN delivers resources on behalf of multiple CDN customers, and, in a CDN there is typically a large number of properties served from the same VIP at each CDN node. When CDN servers are under a DoS attack, it is desirable and sometimes necessary to know which CDN customer is under attack in order for the CDN to mitigate the attack.

It is therefore desirable to provide a way to determine or identify which DNS name (which typically corresponds to a property name) is associated with traffic within the context of a CDN where there are multiple names served from a shared VIP across a number of locations, and where there is insufficient identifying information provided within the request.

### BRIEF DESCRIPTION OF THE DRAWINGS

Other objects, features, and characteristics of the present invention as well as the methods of operation and functions of the related elements of structure, and the combination of parts and economies of manufacture, will become more apparent upon consideration of the following description and the appended claims with reference to the accompanying drawings, all of which form a part of this specification.

FIG. 1 depicts aspects of a content delivery network (CDN) according to exemplary embodiments hereof;

FIG. 2 depicts aspects of a multi-VIP cluster according to exemplary embodiments hereof;

FIGS. 3A-3B depict aspects of mapping structures according to exemplary embodiments hereof;

FIGS. 4A-4B are flowcharts showing aspects of the system according to exemplary embodiments hereof; and

FIG. 5 depicts aspects of computing according to exemplary embodiments hereof.

### DETAILED DESCRIPTION OF THE PRESENTLY PREFERRED EXEMPLARY EMBODIMENTS

### Glossary

As used herein, unless used otherwise, the following terms or abbreviations have the following meanings:

CD means content delivery;

CDN or CD network means content delivery network;

DoS means denial of service;

DDoS means distributed denial of service;

DRDoS means distributed reflected denial of service; and

DNS means domain name system.

A “mechanism” refers to any device(s), process(es), routine(s), service(s), module(s), or combination thereof. A mechanism may be implemented in hardware, software, firmware, using a special-purpose device, or any combination thereof. A mechanism may be integrated into a single device or it may be distributed over multiple devices. The various components of a mechanism may be co-located or distributed. The mechanism may be formed from other mechanisms. In general, as used herein, the term “mechanism” may thus be considered shorthand for the term device(s) and/or process(es) and/or service(s).

### DESCRIPTION

A content delivery network (CDN) distributes content (e.g., resources) efficiently to clients on behalf of one or more content providers, preferably via a public Internet. Content providers provide their content (e.g., resources) via origin sources (origin servers or origins). A CDN can also provide an over-the-top transport mechanism for efficiently sending content in the reverse direction—from a client to an origin server. Both end-users (clients) and content providers benefit from using a CDN. Using a CDN, a content provider is able to take pressure off (and thereby reduce the load on) its own servers (e.g., its origin servers). Clients benefit by being able to obtain content with fewer delays.

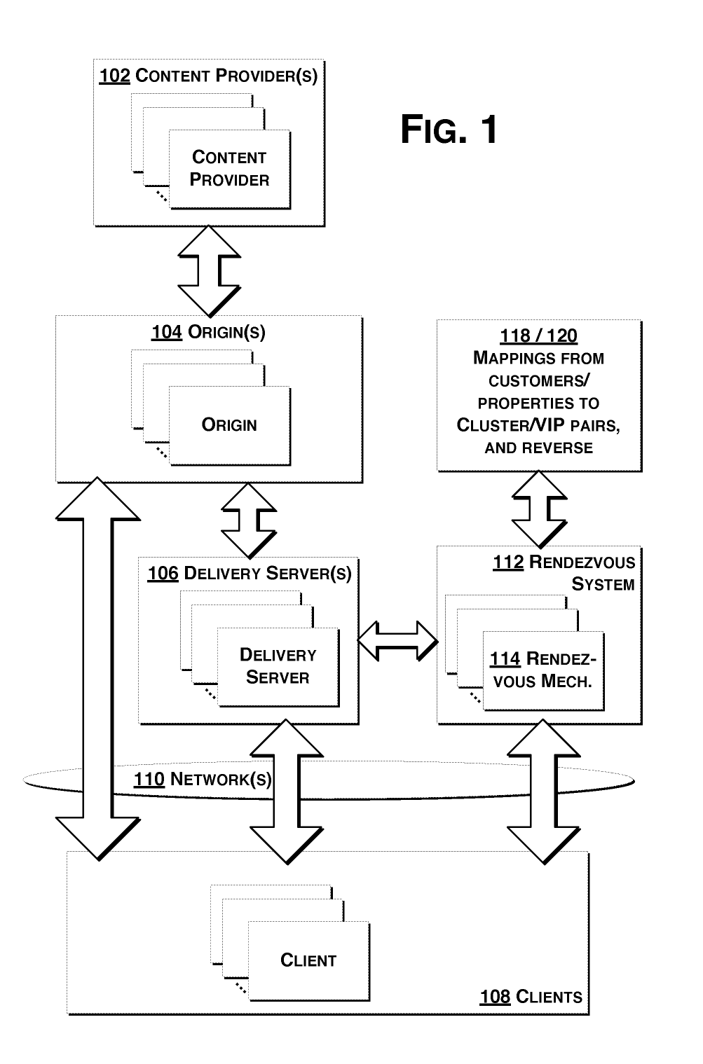

FIG. 1 shows aspects of an exemplary CDN in which one or more content providers 102 provide content via one or more origin sources 104 and delivery services (servers) 106 to clients 108 via one or more networks 110. The delivery services (servers) 106 may form a delivery network from which clients 108 may obtain content. The delivery services 106 may be logically and/or physically organized hierarchically and may include edge caches.

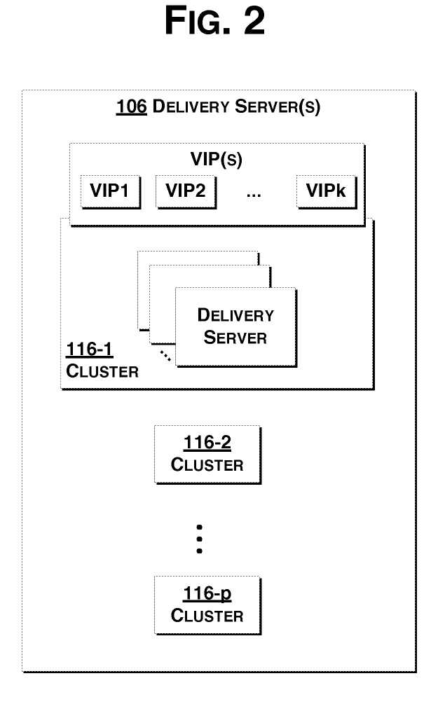

As shown in FIG. 2, the delivery services 106 preferably form clusters 116, with each cluster comprising one or more delivery services (or servers) 106. A cluster may be a logical cluster or a physical cluster. Preferably a local mechanism (e.g., a load balancing mechanism) ensures that exactly one service instance (e.g., machine) in the cluster will respond to each unique service request at the cluster. U.S. Pat. No. 8,015,298 titled “Load Balancing Cluster,” filed Feb. 23, 2009, issued Sep. 6, 2011 (the entire contents of which are fully incorporated herein by reference for all purposes) describes various exemplary approaches to ensure that a service instance in a cluster will respond to each unique service request.

Each cluster 116 is addressable by one or more virtual IP addresses (or VIPs). For example, as shown in FIG. 2, the cluster 116-1 is addressable by the k VIPs (VIP1, VIP2, . . . VIPk). A virtual address may correspond to or be a physical address. For example, a VIP may be (or correspond to) a physical address (e.g., for a single machine cluster). It should be appreciated that the term VIP is used in this description as an example of a virtual address (for an IP based system). In general any kind of virtual addressing scheme may be used and is contemplated herein. Unless specifically stated otherwise, the term VIP is intended as an example of a virtual address, and the system is not limited to or by IP based systems or systems with IP addresses and/or VIPs. As should be appreciated, a logical cluster may be formed from one or more physical clusters. Where some physical clusters are each addressable by only a single VIP, multiple physical clusters at a location may be considered to be a single logical cluster. In these cases (single VIP per physical cluster), the rendezvous system may provide the set of VIPs for the member clusters of the logical cluster, and each client request will be directed to a physical cluster in the logical cluster. As should be appreciated, this approach may not be a preferred implementation, as it likely significantly limits the amount of serving capacity in a location.

As should be appreciated, components of a CDN (e.g., delivery servers or the like) may use the CDN to deliver content to other CDN components. Thus a CDN component may itself be a client of the CDN. For example, the CDN may use its own infrastructure to deliver CDN content (e.g., CDN control and configuration information) to CDN components.

Content associated with or provided by a particular content provider may be referred to as a property. A property may be, e.g., a website and related content, and typically comprises multiple resources. A CDN may provide one or more properties associated with and/or on behalf of one or more content providers. A content provider may have more than one property, and thus a CDN may serve/provide one or more properties associated with and/or on behalf of a particular content provider.

Exemplary CDNs are described in U.S. Pat. Nos. 8,060,613 and 8,825,830, the entire contents of both of which are fully incorporated herein by reference in their entirety and for all purposes.

Client requests (e.g., for content) may be associated with delivery server(s) 106 by a rendezvous system 112 comprising one or more rendezvous mechanism(s) 114, possibly in the form of one or more rendezvous networks. The rendezvous mechanism(s) 114 may be implemented, at least in part, using or as part of a DNS system, and the association of a particular client request (e.g., for content) with one or more delivery servers may be done as part of DNS processing associated with that particular client request (e.g., DNS processing of a domain name associated with the particular client request).

As should be appreciated, typically, multiple delivery servers 106 in the CDN can process or handle any particular client request for content (e.g., for one or more resources). Preferably the rendezvous system 112 associates a particular client request with one or more “best” or “optimal” (or “least worst”) delivery servers 106 (or clusters 116) to deal with that particular request. The “best” or “optimal” delivery server(s) 106 (or cluster(s) 116) may be one(s) that is (are) close to the client (by some measure of network cost) and that is (are) not overloaded. Preferably the chosen delivery server(s) 106 (or cluster(s) 116) (i.e., the delivery server(s) or cluster(s) chosen by the rendezvous system 112 for a client request) can deliver the requested content to the client or can direct the client, somehow and in some manner, to somewhere where the client can try to obtain the requested content. A chosen delivery server 106 (or cluster 116) need not have the requested content at the time the request is made, even if that chosen delivery server 106 (or cluster 116) eventually serves the requested content to the requesting client.

As noted above with respect to FIG. 2, a CDN cluster 116 may be addressable by multiple VIPs, and the rendezvous system 112 directs a client request to a CDN cluster 116 using a VIP associated with that cluster.

The rendezvous system 112 may be implemented, at least in part, as described in U.S. Pat. No. 7,822,871 titled “Configurable Adaptive Global Traffic Control And Management,” filed Sep. 30, 2002, issued Oct. 26, 2010.

Different CDN customers (or properties) may use different VIPs for the same cluster, i.e., a CDN may use a distinctly unique VIP for each property. However, in general, M VIPs may be used for N properties, where N>>M.

As noted above, it is desirable to provide a way to determine or identify which DNS name (which typically corresponds to a property name) is associated with traffic within the context of a CDN where there are multiple names served from a shared VIP across a number of locations, and where there is insufficient identifying information provided within the request. One reason for doing this would be when traffic does not correctly identify itself (e.g., requests are malformed and/or do not contain appropriate identifying elements, for example, missing a “Host” header in an HTTP request), or when a request otherwise fails to complete a connection. The later case includes such cases as incomplete TCP/IP connection establishment, which could be used as a part of a DDoS attempt (essentially, a SYN flood attack). The former may include requests erroneously using HTTP/0.9 or HTTP/1.0 without presenting a “Host” header (e.g., a misbehaving client, etc.) or they may be indicative of an attack.

As is well known, SYN, ACK, and FIN are bits in the TCP (Transmission Control Protocol) header. A SYN is used to indicate the start a TCP session. A FIN is used to indicate the termination of a TCP session. The ACK bit is used to indicate that that the ACK number in the TCP header is acknowledging data. A SYN flood may be noted by an unexpectedly large number of incomplete TCP connections, possibly alerted to by having to eject incomplete connections to make room for new ones and/or an arrival of ACK packets on unknown connections.

DoS attacks typically occur at the TCP level, so it is not possible to know which actual CDN customer or property is under attack. For example, suppose CDN customer #1 with hostname fp.c1.com and CDN customer #2 with hostnames fp.c2A.com and fp.c2B.com both use clusters #1, #2, #3. If the VIPs associated with any of clusters #1, #2, #3 come under DoS attack, it may be that customer #1 or customer #2 is under attack. And if customer #2 is under attack, it may be the web sites at fp.c2A.com and/or fp.c2B.com that are under attack. An attacker typically attacks using an IP address (VIP) that it got from the rendezvous system.

If the system can determine which customer (or web site) is under attack then the system can mitigate that attack (e.g., by directing traffic for that customer via specialized mechanisms that can filter out good requests). These specialized mechanisms cannot generally be used for all traffic as they are expensive and add delay (round-trip time) to requests. A mitigation mechanism or device cannot stop an attack, but is better able to distinguish legitimate traffic and can block bad traffic and absorb the attack and allow legitimate requests to get through.

The inventor realized that a special mapping of CDN customers (or properties) to sets of cluster/VIP pairs can aid in determining which customers and/or properties are under attack, including a DoS attack.

Although the description uses the term “attack” for convenience and to aid this description, the term is intended to cover any situation in which potentially disruptive requests are made in the context of a CDN. The term “attack” is not intended to and does not imply any malice or intent, and may be the result of error, human or otherwise. As used herein, the term “attack” refers, generally, to any anomalous or unusual or potentially disruptive pattern of requests made in the context of a CDN, including, specifically, multiple requests lacking sufficient information to identify a hostname or DNS name or domain name associated with the request.

Assuming that a CDN provides services for n>1 customers or properties (in an exemplary implementation, n may be on the order of 10,000=10⁴). The CDN allocates at least 5 VIPs to each cluster (each VIP being a unique IP address). In general, for k customers, find a value of p such that k≤p^{M}, and allocate at least p VIPs per cluster, wherein M is the number of clusters per identifying group. For the purposes of this discussion, a customer with more than one property (e.g., m>1 properties) is considered to be multiple (m) customers. If fewer than p VIPs can be allocated per cluster then the value of M (the number of clusters per identifying group) needs to be increased. E.g., with 4 clusters and 10 VIPs per cluster, there are 10,000 combinations of VIPs (in this example, M=4, p=10, and p^{M}=10⁴=10,000).

Each customer (or property) is assigned a customer number, e.g., sequentially from 1 to k. The j-th customer is mapped to the clusters/VIPs using a unique mapping from j to the p VIPs associated with each cluster. For example, if j is 21,347 (i.e., this is customer number 21,347), then the customer may use VIP #2 on cluster #1, VIP #1 on cluster #2, VIP #3 on cluster #3, VIP #4 on cluster #4, and VIP #7 on cluster #5.

In general, with this scheme, for customer with customer number x₁x₂ . . . xᵣ, the customer uses VIP #x₁ on cluster #1, VIP #x₂ on cluster #2, etc.

As noted, a customer (CDN subscriber) may use the CDN to serve multiple properties, where each property is addressable by a distinct FQDN. In these cases, since it may be desirable to determine which web site is under attack, each subscriber property may be given a unique identity, and the mapping to cluster/VIP pairs may be done per property instead of per customer.

It should be appreciated that not all clusters need have or use multiple VIPs for identification purposes, but the more that do, the better the likelihood of correctly identifying the target customer/property. For instance, if a metro has 10 clusters within a particular binding, it may be that there is need to identify up to 10,000 customers which requires 4 tracking clusters (assuming 10 VIPs per tracking cluster). Such a system may have two groups of identifying clusters at that location, with 2 clusters left over. The two clusters that are not used may just have single VIPs. Preferably all clusters would have the same number of VIPs, but that is not required or necessary, and a VIP selection process may handle inconsistent VIP counts.

It should also be appreciated that the mechanism used should not prevent the use of any cluster for a given name. For example, each cluster in the Nth position of each cluster group should ideally have the same number of VIPs available. However, if some cluster cannot, then they should just map the range of VIPs expected to be in that cluster to the number actually available. In an extreme case, a particular cluster may only have a single VIP (e.g., because it housed at an ISP that only provides highly limited address space). Such a cluster should ideally not be considered part of an identifying cluster groups, but could just serve all names from the single VIP. This reduces the ability to identify the target of an attack if the attack is only directed to the group that includes such a cluster. For example, if 4 clusters which should have 10 VIPs each are used (for 10,000 properties) but one cluster only has one VIP, then using the other 3 still narrows the set of targets down from 10,000 to 10.

It should further be appreciated that the process described herein may not guarantee absolute protection (e.g., since an attack may have a certain amount of selectivity as to which VIPs it attacks; for instance, an attack may only issue requests against the same ‘digit’ in each identifying cluster group), but it still reduces the search space needed to identify the target of an attack.

Note that a different mapping from customer/property number to VIPs may be used. E.g., a hash of the customer number may be used to generate a mapping to VIPs. When a hash is used, the hash may map the customer/property number to a number in a larger range (i.e., with more digits). For example, if there are on the order of 10,000 customers/properties, then an exemplary hash function may map the customer/property to a number in the range 0 to 100,000 or 0 to 1,000,000, etc. This approach may be used to distribute the customer/property numbers over a larger set of cluster/VIP pairs. For example, the customer numbers 5,432 and 5,433 (out of 10,000) may be hashed to 98,765 and 34,567 (out of 100,000). The distance between the two numbers may make it easier to later distinguish attacks (as described below). If a hash function is used, preferably it distributes its results normally, without clustering.

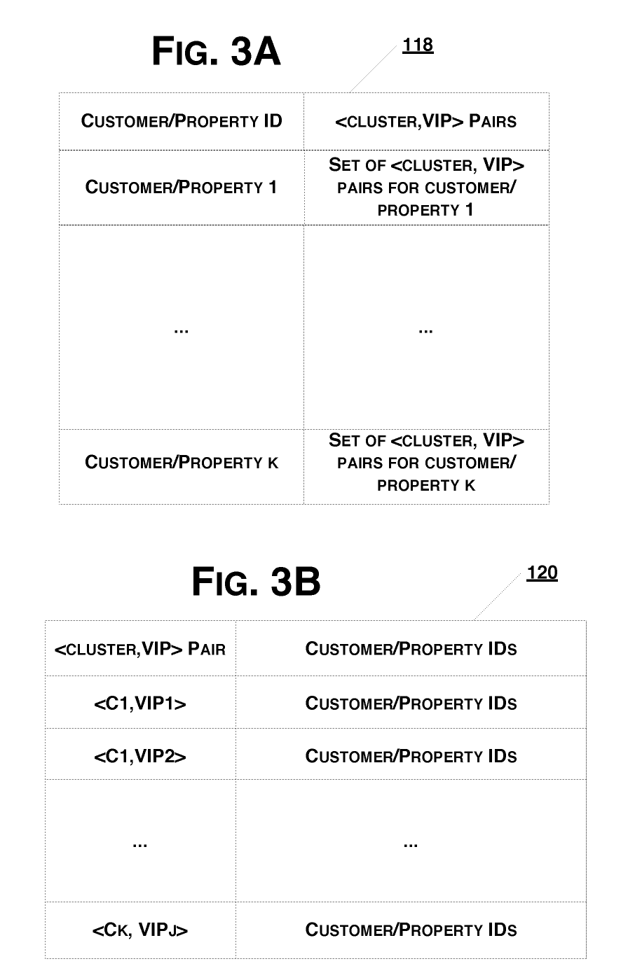

An exemplary mapping 118 from customers/properties to sets of cluster/VIP pairs is shown in FIG. 3. As shown in FIG. 1, the mapping 118 from customers/properties to sets of cluster/VIP pairs is preferably accessible to the rendezvous system 112, and may be stored or co-located therewith.

When a DoS attack is detected, the CDN knows or can determine which VIPs are being targeted. Since the VIPs are unique and each VIP is associated with only one cluster, the CDN effectively knows which cluster/VIP pairs are being attacked. Since the mapping (118, FIG. 3A) from customers/properties to cluster/VIP pairs provides a (full or partial) reverse mapping from cluster/VIP pairs to customers/properties, it can be used to determine one or more customers/properties that may be under attack. This information may then be used to mitigate the attack, e.g., by directing traffic for those customers/properties via mechanism(s) that can mitigate the damage (e.g., by filtering out bad traffic and allowing through valid client requests).

The system is able to query the rendezvous system 112 for a list of all customer/property names that use VIP x on cluster y. A combination of these queries for every VIP/cluster pair under attack will give multiple lists of names, and the intersection of these multiple lists is a candidate list of customers/properties suspected of being under attack.

For example, suppose a CDN customer X with customer number x₁x₂ . . . xᵣ and web site www.x.com is under a DoS attack (i.e., the attack is being made on IP addresses associated with the web site www.x.com, which addresses the attacker obtained from the rendezvous system). Because of the above-described mapping for customer X's property www.x.com, the attacks will be coming in to the CDN to cluster #1 on VIP #x₁, cluster #2 on VIP #x₂, cluster #3 on VIP #x₃, cluster #4 on VIP #x₄, . . . and cluster #p on VIP #xₚ. Assuming a single attack on the CDN, this “signature” of cluster/VIP pairs indicates that the attack is being made against customer X (on web site www.x.com).

As used herein, a customer is considered to be under attack or potentially under attack if all or almost all of the cluster/VIP pairs associated with that customer or property appear to be under attack. A VIP is considered to be under attack or potentially under attack if that VIP is the target of an abnormal or unusual traffic profile (e.g., a stream of SYN requests, or a large number of requests received for invalid property names etc.). It should be appreciated that a customer's property (e.g., a web site) may receive unusual or abnormal traffic for non-malicious reasons (e.g., it suddenly becomes extremely popular). Note that an attack may be regional, affecting a number of VIPs in some location(s) which could result in denying service to them which may then be considered disruptive (performance may degrade to the point of being problematic as opposed to a wholesale loss of availability).

Having determined which property (hostname) is under attack; the CDN may cause the rendezvous system 112 to redirect traffic for that property via a special DoS mitigation mechanism that can filter out bad traffic.

A DoS attack on a particular CDN customer/property typically hits all VIPs associated with that CDN customer/property. However, in some cases a DoS attack on a particular CDN customer/property may not be hitting all VIPs/clusters associated with that particular CDN customer/property. In such cases, the system may not be able to determine a single CDN customer/property under attack, though it may use the above mapping to provide a reduced list of candidate CDN customers/properties that might be under attack. The system may then use mitigation measures or further analysis on this reduced list to determine the particular CDN customer/property under attack.

For example, consider again CDN customer X with customer number x₁x₂ . . . xᵣ and web site www.x.com and CDN customer Y with customer number x₁x₂ . . . xₘ and web site www.y.com. The customer numbers for these two CDN customers (X and Y) differ only in the last digit. Therefore both of them will map to the same cluster/VIP pairs for all but one digit (customer X will map to cluster #p on VIP #xₚ and customer Y will map to cluster #p on VIP #xₘ). If, for some reason, no attacks are coming in on cluster #p or on VIPS #xₘ or #xₚ, then the system will be unable to tell whether the attack is against customer X or customer Y, but can consider them both as candidates.

As noted above, if a hash function is used to map the customer/property identifiers to a number in a larger range than the range of customer numbers, then there may be less likelihood of clashes over too many cluster/VIP pairs (as in the previous example). With an appropriate hash function (e.g., that distributes normally over a larger range than the range of customer numbers), adjacent customer numbers will be further apart after hashing, thereby reducing the ambiguity when one of them is attacked on fewer than all of its VIPs.

One way to prune or narrow a list of candidates under attack is to re-allocate the cluster/VIP pairs for the candidates under attack. For example, each candidate CDN customer/property has one or more additional cluster/VIP pairs, with the additional cluster/VIP pairs being distinct for each candidate CDN customer/property. Thus, in the example above, once customers X and Y are candidates (i.e., at least one of them is under attack, but the system cannot tell which one), then customer X can be allocated another VIP (VIP-x) and customer Y can be allocated another VIP (VIP-y). VIP-x can be associated with a cluster that is already handling customer X or with another cluster that has not handled customer X. Similarly, VIP-y can be associated with a cluster that is already handling customer Y or with another cluster that has not handled customer Y. The associations of these new VIPs (VIP-x and VIP-y) with customers X and Y, respectively, are preferably made at the rendezvous system 112 (e.g., by updating DNS records). If the attacks are being made via the rendezvous system 112 (e.g., if each attack is doing a hostname lookup), then the new VIPs will propagate into the network and the DoS attack will start to occur on one of VIP-x or VIP-y (assuming only one of the customers is under attack).

Those of ordinary skill in the art will realize and appreciate, upon reading this description, that there may be multiple ongoing DoS attacks going on at the same time. In such cases, it may not be possible to determine which CDN customers/properties are under attack, but the above-described system may be used to produce a pruned list of candidates that can be used for further mitigation.

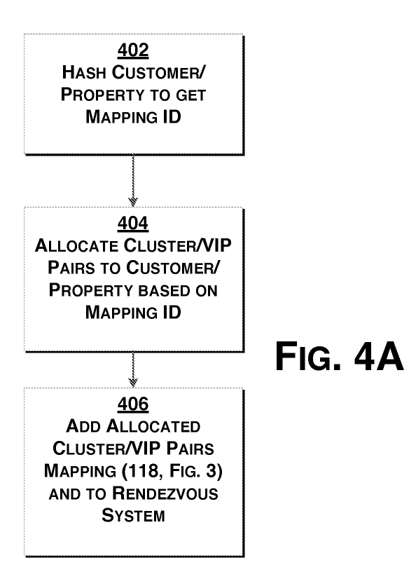

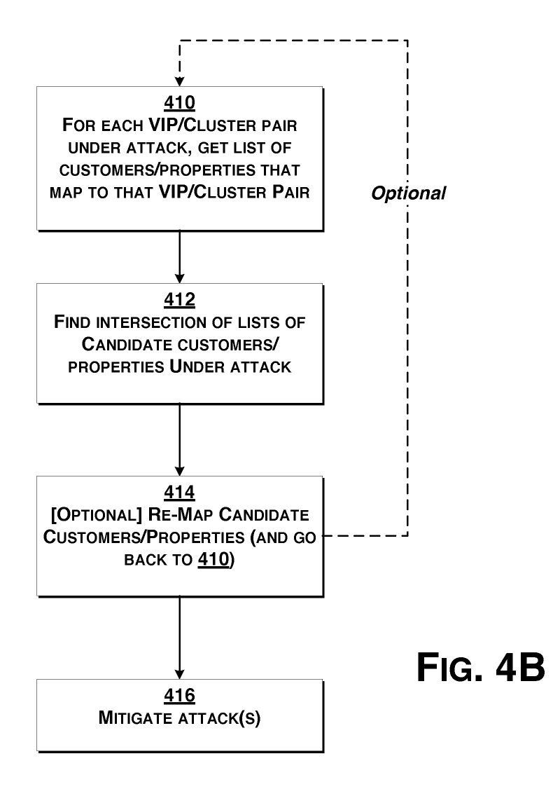

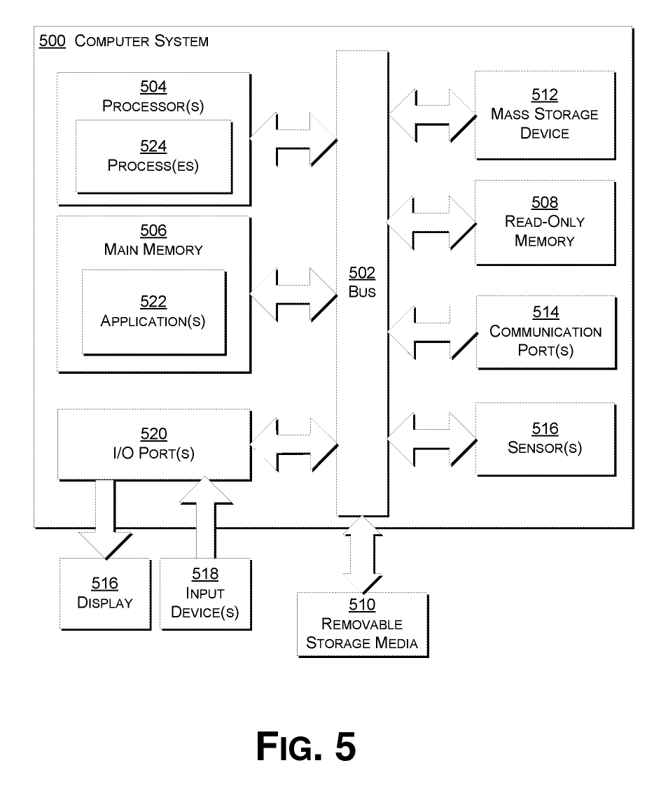

FIGS. 4A-4B are flowcharts showing aspects of the system according to exemplary embodiments hereof.

When a customer/property is added to the CDN (e.g., when a new customer subscribes to the CDN or when an existing customer adds a new property to the CDN), the customer or property is assigned a new customer/property identifier. Identifiers may be assigned in sequential order. As shown in FIG. 4A, when a customer/property is added to the CDN, the customer/property identifier is hashed (as described above) to obtain a mapping identifier (at 402). Preferably the range of the mapping identifier is greater than the range of customer/property identifiers, so as to allow room for growth of the system and to minimize overlap. The system then allocates a set of cluster/VIP pairs to the customer/property based on the mapping identifier (at 404), as described above, and this mapping is stored in the mapping table 118. For example, the customer/property number X (x₁x₂ . . . xᵣ) may hash to the mapping identifier M₁M₂ . . . Mₛ, where s≥r. In this case, the system allocates a set of cluster/VIP pairs to the customer/property as follows: {VIP #M₁ on cluster #1, VIP #M₂ on cluster #2, . . . VIP #M, on cluster #S}. The rendezvous system 112 (e.g., the DNS system) updates its records (at 406) so that requests for the customer/property will be directed to one or more of the VIPS in the set {VIP #M₁; VIP #M₂; . . . VIP #Mₛ}. As will be appreciated, the rendezvous system provides one or more VIPs to requesting clients, and does not provide any cluster information.

When a CDN is under a DoS attack, then, as shown in FIG. 4B, for each VIP/Cluster pair under attack, the system gets a list of customers/properties that map to that VIP/Cluster pair (at 410). These lists may be obtained from the mapping table 118, or a reverse lookup table may be created and stored that maps VIP/Cluster pairs to customer numbers (120, FIG. 3B). These lists are candidates of customers/properties that may be under attack, and may require pruning. Accordingly, an intersection of these lists is determined (at 412) to determine a potentially narrower list of candidate customers/properties under attack.

In some cases, the system may re-map the candidate customers/properties to a different set of cluster/VIP pairs (at 414), e.g., by adding VIPs to existing clusters or adding new cluster/VIPs. If the candidates are remapped then the system repeats the determination of the candidate lists (as described above with respect to acts 410 and 412).

Those of ordinary skill in the art will realize and appreciate, upon reading this description, that target identification may be achieved without storing a mapping (as described above), although such an implementation may make it more difficult to “map” in reverse, from the set of targeted VIPs to the targeted customer/property. E.g., the hash of the property name may be calculated when needed rather than being stored in a mapping table.

Once a set of candidate customers/properties that are likely under attack is determined, the system may mitigate the attack (at 416), e.g., by directing traffic to the effected customers/properties via mitigation mechanisms.

The use of multiple VIPs described here supports various mitigation options.

If an attacker is honoring DNS names (i.e., attacking via the rendezvous DNS system), then once the target customer/property is identified, it may be reasonable to alter that name (those names) so that it is (they are) sent to a scrubber. However, if the attack is not honoring DNS (e.g., if the attacker used DNS once to identify a target set of VIPs and then is just attacks them as discrete IP addresses), it would be reasonable to block those VIPs across the set of target clusters. In the normal CDN case (one VIP per cluster), this would remove those clusters from being able to serve traffic—with this approach, a firewall change may be applied to block the targeted VIPs only. For example, assuming 10 VIPs per cluster, this would mean that 9:10 would still be available at each cluster (or rather, 1:10 VIPs would be blocked), but only after configuring DNS to no longer hand out those VIPs for the names not associated with the attack. Each such customer would see some slight reduction in availability—the other names allocated to that VIP at each cluster might either be denied access to that cluster, or be shifted to alternate VIPs on the cluster; but their end-users' traffic using the “bad” VIP might be impacted when the firewall was altered (although they were presumably already getting bad service from that VIP due to the ongoing attack).

Note that switching to a different VIP on a single VIP cluster would be possible in the case of the attack not honoring TTLs, but that the impact would be more noticeable on the non-targeted names.

### Computing

The services, mechanisms, operations and acts shown and described above are implemented, at least in part, by software running on one or more computers of a CDN.

Programs that implement such methods (as well as other types of data) may be stored and transmitted using a variety of media (e.g., computer readable media) in a number of manners. Hard-wired circuitry or custom hardware may be used in place of, or in combination with, some or all of the software instructions that can implement the processes of various embodiments. Thus, various combinations of hardware and software may be used instead of software only.

One of ordinary skill in the art will readily appreciate and understand, upon reading this description, that the various processes described herein may be implemented by, e.g., appropriately programmed general purpose computers, special purpose computers and computing devices. One or more such computers or computing devices may be referred to as a computer system.

FIG. 5 is a schematic diagram of a computer system 500 upon which embodiments of the present disclosure may be implemented and carried out.

According to the present example, the computer system 500 includes a bus 502 (i.e., interconnect), one or more processors 504, a main memory 506, read-only memory 508, removable storage media 510, mass storage 512, and one or more communications ports 514. Communication port 514 may be connected to one or more networks by way of which the computer system 500 may receive and/or transmit data.

As used herein, a “processor” means one or more microprocessors, central processing units (CPUs), computing devices, microcontrollers, digital signal processors, or like devices or any combination thereof, regardless of their architecture. An apparatus that performs a process can include, e.g., a processor and those devices such as input devices and output devices that are appropriate to perform the process.

Processor(s) 504 can be any known processor, such as, but not limited to, an Intel® Itanium® or Itanium 2® processor(s), AMD® Opteron® or Athlon MP® processor(s), or Motorola® lines of processors, and the like. Communications port(s) 514 can be any of an RS-232 port for use with a modem based dial-up connection, a 10/100 Ethernet port, a Gigabit port using copper or fiber, or a USB port, and the like. Communications port(s) 514 may be chosen depending on a network such as a Local Area Network (LAN), a Wide Area Network (WAN), a CDN, or any network to which the computer system 500 connects. The computer system 500 may be in communication with peripheral devices (e.g., display screen 516, input device(s) 518) via Input/Output (I/O) port 520.

Main memory 506 can be Random Access Memory (RAM), or any other dynamic storage device(s) commonly known in the art. Read-only memory 508 can be any static storage device(s) such as Programmable Read-Only Memory (PROM) chips for storing static information such as instructions for processor 504. Mass storage 512 can be used to store information and instructions. For example, hard disks such as the Adaptec® family of Small Computer Serial Interface (SCSI) drives, an optical disc, an array of disks such as Redundant Array of Independent Disks (RAID), such as the Adaptec® family of RAID drives, or any other mass storage devices may be used.

Bus 502 communicatively couples processor(s) 504 with the other memory, storage, and communications blocks. Bus 502 can be a PCI/PCI-X, SCSI, a Universal Serial Bus (USB) based system bus (or other) depending on the storage devices used, and the like. Removable storage media 510 can be any kind of external hard-drives, floppy drives, IOMEGA® Zip Drives, Compact Disc-Read Only Memory (CD-ROM), Compact Disc-Re-Writable (CD-RW), Digital Versatile Disk-Read Only Memory (DVD-ROM), etc.

Embodiments herein may be provided as one or more computer program products, which may include a machine-readable medium having stored thereon instructions, which may be used to program a computer (or other electronic devices) to perform a process. As used herein, the term “machine-readable medium” refers to any medium, a plurality of the same, or a combination of different media, which participate in providing data (e.g., instructions, data structures) which may be read by a computer, a processor or a like device. Such a medium may take many forms, including but not limited to, non-volatile media, volatile media, and transmission media. Non-volatile media include, for example, optical or magnetic disks and other persistent memory. Volatile media include dynamic random access memory, which typically constitutes the main memory of the computer. Transmission media include coaxial cables, copper wire and fiber optics, including the wires that comprise a system bus coupled to the processor. Transmission media may include or convey acoustic waves, light waves and electromagnetic emissions, such as those generated during radio frequency (RF) and infrared (IR) data communications.

The machine-readable medium may include, but is not limited to, floppy diskettes, optical discs, CD-ROMs, magneto-optical disks, ROMs, RAMs, erasable programmable read-only memories (EPROMs), electrically erasable programmable read-only memories (EEPROMs), magnetic or optical cards, flash memory, or other type of media/machine-readable medium suitable for storing electronic instructions. Moreover, embodiments herein may also be downloaded as a computer program product, wherein the program may be transferred from a remote computer to a requesting computer by way of data signals embodied in a carrier wave or other propagation medium via a communication link (e.g., modem or network connection).

Various forms of computer readable media may be involved in carrying data (e.g. sequences of instructions) to a processor. For example, data may be (i) delivered from RAM to a processor; (ii) carried over a wireless transmission medium; (iii) formatted and/or transmitted according to numerous formats, standards or protocols; and/or (iv) encrypted in any of a variety of ways well known in the art.

A computer-readable medium can store (in any appropriate format) those program elements that are appropriate to perform the methods.

As shown, main memory 506 is encoded with application(s) 522 that supports the functionality discussed herein (the application 522 may be an application that provides some or all of the functionality of the CD services described herein, including rendezvous services). Application(s) 522 (and/or other resources as described herein) can be embodied as software code such as data and/or logic instructions (e.g., code stored in the memory or on another computer readable medium such as a disk) that supports processing functionality according to different embodiments described herein.

During operation of one embodiment, processor(s) 504 accesses main memory 506 via the use of bus 502 in order to launch, run, execute, interpret or otherwise perform the logic instructions of the application(s) 522. Execution of application(s) 522 produces processing functionality of the service related to the application(s). In other words, the process(es) 524 represent one or more portions of the application(s) 522 performing within or upon the processor(s) 504 in the computer system 500.

It should be noted that, in addition to the process(es) 524 that carries (carry) out operations as discussed herein, other embodiments herein include the application 522 itself (i.e., the un-executed or non-performing logic instructions and/or data). The application 522 may be stored on a computer readable medium (e.g., a repository) such as a disk or in an optical medium. According to other embodiments, the application 522 can also be stored in a memory type system such as in firmware, read only memory (ROM), or, as in this example, as executable code within the main memory 506 (e.g., within Random Access Memory or RAM). For example, application 522 may also be stored in removable storage media 510, read-only memory 508 and/or mass storage device 512.

Those skilled in the art will understand that the computer system 500 can include other processes and/or software and hardware components, such as an operating system that controls allocation and use of hardware resources.

As discussed herein, embodiments of the present invention include various steps or operations. A variety of these steps may be performed by hardware components or may be embodied in machine-executable instructions, which may be used to cause a general-purpose or special-purpose processor programmed with the instructions to perform the operations. Alternatively, the steps may be performed by a combination of hardware, software, and/or firmware. The term “module” refers to a self-contained functional component, which can include hardware, software, firmware or any combination thereof.

One of ordinary skill in the art will readily appreciate and understand, upon reading this description, that embodiments of an apparatus may include a computer/computing device operable to perform some (but not necessarily all) of the described process.

Embodiments of a computer-readable medium storing a program or data structure include a computer-readable medium storing a program that, when executed, can cause a processor to perform some (but not necessarily all) of the described process.

Where a process is described herein, those of ordinary skill in the art will appreciate that the process may operate without any user intervention. In another embodiment, the process includes some human intervention (e.g., a step is performed by or with the assistance of a human).

As used herein, including in the claims, the phrase “at least some” means “one or more,” and includes the case of only one. Thus, e.g., the phrase “at least some services” means “one or more services”, and includes the case of one service.

As used herein, including in the claims, the phrase “based on” means “based in part on” or “based, at least in part, on,” and is not exclusive. Thus, e.g., the phrase “based on factor X” means “based in part on factor X” or “based, at least in part, on factor X.” Unless specifically stated by use of the word “only”, the phrase “based on X” does not mean “based only on X.”

As used herein, including in the claims, the phrase “using” means “using at least,” and is not exclusive. Thus, e.g., the phrase “using X” means “using at least X.” Unless specifically stated by use of the word “only”, the phrase “using X” does not mean “using only X.”

In general, as used herein, including in the claims, unless the word “only” is specifically used in a phrase, it should not be read into that phrase.

As used herein, including in the claims, the phrase “distinct” means “at least partially distinct.” Unless specifically stated, distinct does not mean fully distinct. Thus, e.g., the phrase, “X is distinct from Y” means that “X is at least partially distinct from Y,” and does not mean that “X is fully distinct from Y.” Thus, as used herein, including in the claims, the phrase “X is distinct from Y” means that X differs from Y in at least some way.

As used herein, including in the claims, a list may include only one item, and, unless otherwise stated, a list of multiple items need not be ordered in any particular manner. A list may include duplicate items. For example, as used herein, the phrase “a list of CDN services” may include one or more CDN services.

It should be appreciated that the words “first” and “second” in the description and claims are used to distinguish or identify, and not to show a serial or numerical limitation. Similarly, the use of letter or numerical labels (such as “(a)”, “(b)”, and the like) are used to help distinguish and/or identify, and not to show any serial or numerical limitation or ordering.

No ordering is implied by any of the labeled boxes in any of the flow diagrams unless specifically shown and stated. When disconnected boxes are shown in a diagram, the activities associated with those boxes may be performed in any order, including fully or partially in parallel.

While the invention has been described in connection with what is presently considered to be the most practical and preferred embodiments, it is to be understood that the invention is not to be limited to the disclosed embodiment, but on the contrary, is intended to cover various modifications and equivalent arrangements included within the spirit and scope of the appended claims.

I claim:

1. A computer-implemented method, in a content delivery (CD) network, wherein said CD network delivers content on behalf of multiple content providers, the method comprising:
(A) maintaining a mapping having, for at least some of said content providers, a corresponding set of cluster/virtual IP (VIP) address pairs, wherein each cluster has multiple VIPs, and wherein each of said at least some of said content providers is mapped to at most one VIP per cluster, and wherein client requests for content from a particular content provider are directed to one or more VIPs in the set of cluster/VIP pairs associated with that particular content provider; and then
(B) for each particular VIP of a plurality of VIPs, determining, based on the mapping, a corresponding set of candidate content providers that map to that particular VIP; and
(C) finding, as a set of one or more possible attack candidates, an intersection of the sets of candidate content providers determined in (B); and
(D) attempting to mitigate attacks on the possible attack candidates.

2. The method of claim 1 wherein each content provider of the multiple content providers is a customer of the CDN, and wherein each said content provider has a corresponding unique identifier associated therewith, and wherein said set of cluster/VIP pairs associated with each content provider is determined based on the unique identifier associated with that content provider.

3. The method of claim 2 wherein said set of cluster/VIP pairs associated with each content provider is determined based on a hash function applied to the unique identifier associated with that content provider.

4. The method of claim 1 wherein said plurality of VIPs in (B) are VIPs that appear to be under attack.

5. The method of claim 1 wherein the set of one or more possible attack candidates contains one or more content providers that is under a distributed denial of service (DDoS) attack.

6. The method of claim 5 wherein the set of one or more possible attack candidates contains only one content provider.

7. The method of claim 1 further comprising:
(C)(2) after said finding in (C), modifying said mapping for content providers in said set of one or more possible attack candidates, and then repeating acts (B) and (C) using the modified mapping.

8. The method of claim 7 wherein, for a particular content provider in the set of one or more possible attack candidates, the modified mapping adds at least one cluster/VIP pair.

9. The method of claim 1 wherein said attempting to mitigate attacks in (D) comprises:
directing traffic associated with at least some of said plurality of VIPs via one or more mitigation mechanisms.

10. The method of claim 1 wherein said attempting to mitigate attacks in (D) comprises:
(D)(1) determining, from said possible attack candidates, a set of one or more targeted VIPs;
(D)(2) determining a second set of one or more content providers (i) not in said set of possible attack candidates, and (ii) using said targeted VIPs;
(D)(3) altering said mapping for at least some content providers in said second set to one or more alternate VIPs.

11. The method of claim 10 wherein said targeted VIPs are at one or more affected clusters, and wherein said one or more alternate VIPs in (D)(3) comprise one or more non-targeted VIPs at said one or more affected clusters.

12. The method of claim 1 wherein the set of cluster/VIP pairs is unique for each content provider.

13. The method of claim 1 wherein each content provider has a unique VIP at each of a plurality of clusters.

14. The method of claim 1 wherein said mapping is maintained in (A) for all the multiple content providers.

15. A computer-implemented method, in a content delivery network (CDN), wherein said CDN delivers content on behalf of multiple content providers, said content for each content provider comprising one or more properties, the method comprising:
(A) maintaining a mapping having, for each property of at least some of said content providers, a corresponding set of cluster/virtual IP (VIP) address pairs, wherein each cluster has multiple VIPs, and wherein each property of said at least some of said content providers is mapped to at most one VIP per cluster, wherein client requests for content from a particular property of a particular content provider are directed to one or more VIPs in the set of cluster/VIP pairs associated with that particular property; and then (B) for each particular VIP of a plurality of VIPs, determining, based on the mapping, a corresponding set of candidate properties that map to that particular VIP; and
(C) finding, as a set of one or more possible attack candidates, an intersection of the sets of candidate properties determined in (B); and
(D) attempting to mitigate attacks on the possible attack candidates.

16. The method of claim 15 wherein the set of cluster/VIP pairs is unique for each property of each of said at least some of said content providers.

17. An article of manufacture comprising a computer-readable medium having program instructions stored thereon, the program instructions, operable on a computer system in a content delivery network (CDN), said device implementing at least one content delivery (CD) service, wherein execution of the program instructions by one or more processors of said computer system causes the one or more processors to carry out the acts of:
(A) maintaining a mapping having, for at least some of said content providers, a corresponding set of cluster/virtual IP (VIP) address pairs, wherein each cluster has multiple VIPs, and wherein each of said at least some of said content providers is mapped to at most one VIP per cluster, and wherein client requests for content from a particular content provider are directed to one or more VIPs in the set of cluster/VIP pairs associated with that particular content provider; and then
(B) for each particular VIP of a plurality of VIPs, determining, based on the mapping, a corresponding set of candidate content providers that map to that particular VIP; and
(C) finding, as a set of one or more possible attack candidates, an intersection of the sets of candidate content providers determined in (B); and
(D) attempting to mitigate attacks on the possible attack candidates.

18. The article of manufacture of claim 17, wherein each content provider of the multiple content providers is a customer of the CDN, and wherein each said content provider has a corresponding unique identifier associated therewith, and wherein said set of cluster/VIP pairs associated with each content provider is determined based on the unique identifier associated with that content provider.

19. A device in a content delivery network (CDN), wherein said CDN delivers content on behalf of at least one content provider, said device implementing a content delivery (CD) service, the device:
(A) maintaining a mapping having, for at least some of said content providers, a corresponding set of cluster/virtual IP (VIP) address pairs, wherein each cluster has multiple VIPs, and wherein each of said at least some of said content providers is mapped to at most one VIP per cluster, and wherein client requests for content from a particular content provider are directed to one or more VIPs in the set of cluster/VIP pairs associated with that particular content provider; and then
(B) for each particular VIP of a plurality of VIPs, determining, based on the mapping, a corresponding set of candidate content providers that map to that particular VIP; and
(C) finding, as a set of one or more possible attack candidates, an intersection of the sets of candidate content providers determined in (B); and
(D) attempting to mitigate attacks on the possible attack candidates.

20. The device of claim 19, wherein each content provider of the multiple content providers is a customer of the CDN, and wherein each said content provider has a corresponding unique identifier associated therewith, and wherein said set of cluster/VIP pairs associated with each content provider is determined based on the unique identifier associated with that content provider.
